(19) United States
(12) Patent Application Publication
(10) Pub. No.: US 2009/0021813 A1
(43) Pub. Date: Jan. 22, 2009

(54) System and method for electronically displaying holographic images

(76) Inventor: Peter N. Moore, Chicago, IL (US)

Correspondence Address: Peter N. Moore, 3319 N. Sheffield Ave. #1, Chicago, IL, 60657, US

(21) Appl. No.: 12/218,130

(22) Filed: Jul. 11, 2008

Related U.S. Application Data
(60) Provisional application No. 60/949,943, filed on Jul. 16, 2007.

(51) Int. Cl. G03H 1/10; G02B 5/32

(52) U.S. Cl. 359/10; 359/15

(57) ABSTRACT

A system and method for displaying holographic images to the naked eye. The scattering of light by objects in real space is simulated using a two-dimensional holographic display, giving images depth. The display comprises a plurality of small holographic pixels, each displaying a different perspective of the three dimensional space. In some embodiments, digital micromirror devices (DMDs), which are a well developed technology, are combined with simple optical lenses. Other embodiments include the ability to display holographic images from a distant source in real time, or from a recording.

### CROSS REFERENCE TO RELATED APPLICATIONS

This application claims the benefit of U.S. Provisional Application No. 60/949,943 filed Jul. 16, 2007, which is hereby incorporated by reference.

### FIELD OF THE INVENTION

The invention relates to a system and method for electronically displaying holographic images that appear three dimensional and display depth when viewed with the naked eye.

### BACKGROUND OF THE INVENTION

Current technology involving three dimensional imagery generally falls under one of two categories: laser illuminated interference patterns, called holograms, and stereoscopic moving images, sometimes referred to as “3D movies.”

The former category of holograms are traditionally created using standard photographic film. A coherent light source, such as a laser, is split at a an angle. The first split of the beam is used to illuminate the object to be photographed and is imprinted on the film. Simultaneously, the second split of the beam is also directed at the film at a different predetermined angle from that of the object. In this fashion, the interference of the two beams, one pure, the other scattered by the object, produces a diffraction grating on the film. When the diffraction grating is illuminated again, the grating scatters the light in the same pattern as it was originally shone on the film, producing an image appearing three dimensional, with full depth of field, and which can be viewed from different angles and distances, appearing to exist in space, rather than on a plane.

This diffraction grating can be electronically simulated using a high resolution pixilated light source, i.e., a light source capable of displaying rays of light in small, discrete units called pixels, such as a Digital Micromirror Device (DMD) or Liquid Crystal on Silicon (LCoS) chip, as shown in U.S. Pat. No. 6,646,773 (Garner). However, this technology still relies on coherent light (i.e., lasers), and the images produced are usually monochromatic and low resolution. Further, interference-based digital holograms tend to display shades of color very poorly, resulting from unpredictable diffraction patterns inherent in the methods that microscopic light arrays use to produce grayscale.

The second category, stereoscopic moving images, is possible because of binocularity in humans. A moving image is recorded by two cameras separated by approximately the same distance as human eyes. In a theater, the two recordings are superimposed using polarizing filters such that one image is polarized by 90 degrees with respect to the first. Viewers wear polarized glasses that filter each image to the correct eye. The viewer, thus, “sees” a stereo image.

The major disadvantage of stereoscopic moving images is that viewers are required to wear special glasses to view the polarized images correctly. Further, depth of field is not observed in each eye, i.e., the eye cannot focus on different parts of an image. Instead, each eye sees a single, two-dimensional image which remains static when viewed from any angle or distance. It has been shown that variable focal length lenses can direct light from 2 dimensional images to the appropriate eye, avoiding the need for 3D glasses, though such images would still not display depth of field. An attempt to solve this problem is shown in U.S. patent application Ser. No. 11/520,355 (Yamada), whereby a single image representing a space is displayed, while individual portions of the image are focused by variable focal length lenses, altering the wave-front of the light generated by each portion to simulate the depths of different portions of the image. This technique still, however, requires specifically directing different images to each eye of a viewer, reducing the flexibility of the display, and therefore does not simulate a true hologram.

It is, thus, an object of the present invention to provide a means for electronically producing three dimensional images that exhibit depth of field and appear to the naked eye as though existing in space when viewed from different angles and distances, without the need for coherent light illumination or the need to differentiate between images viewed by the left or right eye. It is also an object of the present invention to allow such an image to be created by photographing normal environments using any light source, or to be generated by a computer.

### BRIEF SUMMARY OF THE INVENTION

A system and method for electronically displaying holographic images are disclosed. Data representing a three dimensional space are generated by a computer or recording device, or stored in a suitable data storage medium, and transmitted to a holographic display. The holographic display comprises a plurality of pixilated light sources each transmitting a plurality of light rays in controlled directions. Each pixel in a pixilated light source represents a different point in the three dimensional space, and each pixilated light source represents a different perspective of the three dimensional space.

In one preferred embodiment, a two dimensional array of pixilated light sources (such as DMDs or LCoS devices) coupled to a controller is paired with an array of corresponding optical elements, such as lenses, to create a holographic display.

In this embodiment, each pixilated light source shines collimated light upon a corresponding lens. In this fashion, thousands of light rays can each be transmitted in a desired direction, and therefore the scattering of light rays by real objects in space can be recreated. The viewer sees a three dimensional image as though looking through a window. Further, in this embodiment the light source itself need be collimated, but need not be coherent (i.e., it need not be a laser).

Both the resolution and quantity of the pixilated light sources determine the clarity of the resulting image. While the image created by a single pixilated light source is merely a two-dimensional projection of a three dimensional space, each light source representing the same space adds to the depth of the image and increases the size and clarity of the display. With sufficient resolution and quantity of the light sources, the images converge upon the viewer's eyes to create a three dimensional virtual image.

### BRIEF DESCRIPTION OF THE DRAWINGS

FIG. 1 represents the path of light rays from points in real space through an optical lens.

FIG. 2 represents the simulation of light rays originating from points in real space using an array of holographic pixels.

FIG. 3 represents using a lens to control the direction of light rays emanating from a pixilated light source.

FIG. 4 represents a plurality of holographic pixels coupled to a controller and storage device.

FIG. 5 represents the simulation of light rays from a point in real space using a ray tracing technique.

FIG. 6 represents the display of light rays originating at a point in real space being recorded by light sensitive devices.

### DETAILED DESCRIPTION OF THE INVENTION

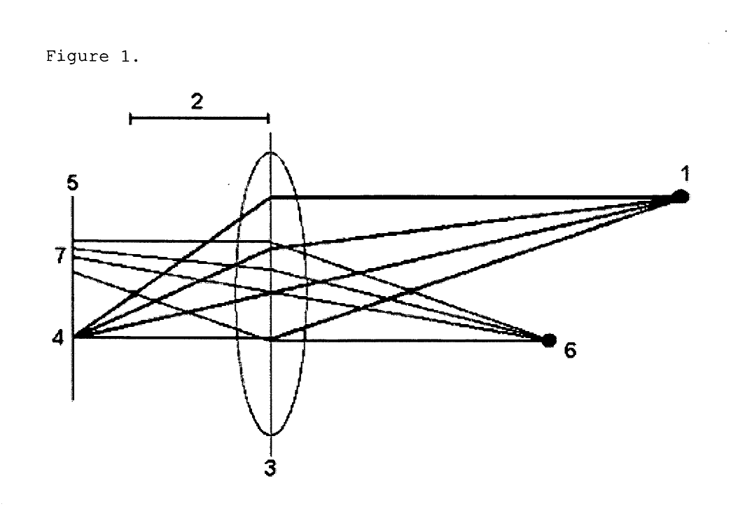

Objects appear to have depth because the human eye contains a converging lens which allows the eye to focus on different depths in space. The focusing of light by a lens depends upon on the position and angle at which a light ray strikes the lens, according to Snell's Law and the Lens Equation, as seen in FIG. 1.

To focus on a point in space (1), the focal length (2) of the lens (3) in the eye adjusts so that the light rays originating from that point in space (1) converge at the same location (4) on the retina (5), while light rays originating from a point in space not in focus (6) are scattered by the lens (3), making them strike different locations (7) on the retina (5) and thus appear blurry.

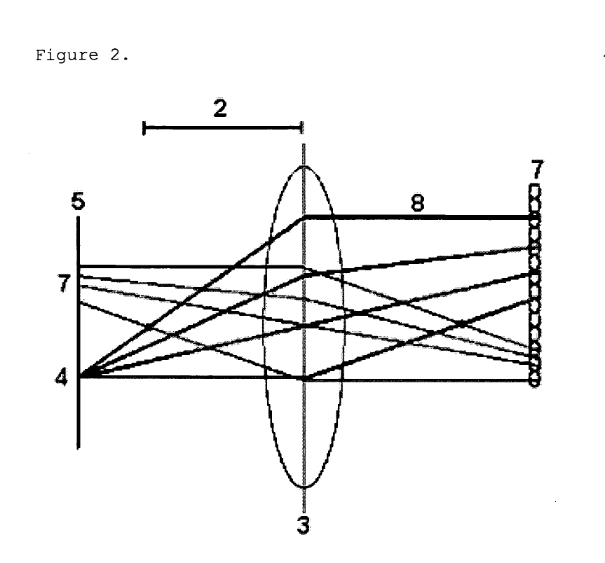

If light rays strike a lens at appropriate positions and angles, however, the lens (3) will cause the rays to converge at a single point on the retina (5), regardless of where in space the rays actually originated, as seen in FIG. 2. Points (1) and (6), which were real objects, have now been replaced by an array (7) of holopixels. A holopixel is defined as a pixilated light source transmitting a plurality of light rays in controlled directions. Using sufficient holopixels, the scattering of light by the original points (1) and (6) can be simulated, as though each holopixel were a small rectangular section of a mirror or window.

Consequently, when the light transmitted by the holopixel array (7) passes through the converging lens (3) of an eye or camera, the resulting image appears as though originating from real objects (1) and (6) in FIG. 1 and can be focused upon as though existing in real space. Movement of the eye or camera with respect to the array (7) will result in parallax, and consequently stereoscopic vision (binocularity) is achieved without the need to direct unique images to each eye, as is optical depth perception, i.e., the ability to focus on different parts of the image, without the need for special viewing glasses.

This is possible because each holopixel represents the same three dimensional space, but from a different perspective, like a small rectangular piece of a mirror or window. The more holopixels representing a particular object or point, the greater the clarity of that object when in the focus of the viewer and, conversely, the more blurry the object will appear when not in focus, as shown in FIGS. 1 and 2, for example, where a point (1) in real space is represented by four holopixels in the array (7), and therefore strikes the retina (5) at a focused point (4). Practical limits exist, of course, at the extremes of the display and of the space represented by the display. For instance, the center of the display will naturally offer the greatest fidelity of the represented space when viewed head on, but an ideal display will preferably offer significant freedom of movement for the viewer, allowing him to see different portions of the represented space from different perspectives.

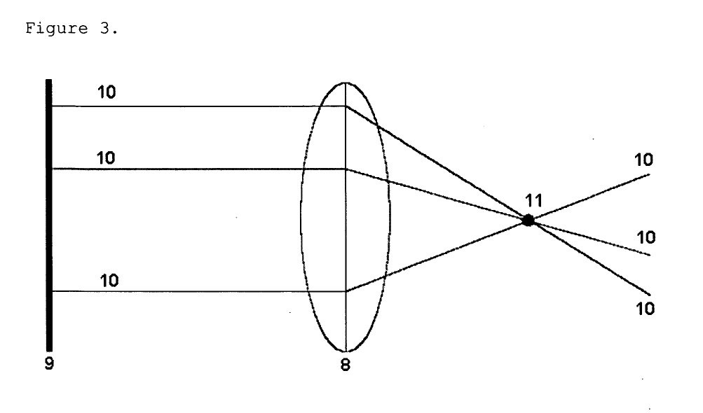

Many methods of constructing holopixels are possible; however, several exemplary methods will be discussed below. Referring now to FIG. 3, one type of holopixel is disclosed. A lens (8) is paired with a two dimensional pixilated light source (9), such as a Digital Micromirror Device (DMD) chip. The pixilated light source (9) transmits a plurality of light rays (10) that strike the lens (8) at a 90 degree angle. This causes each light ray (10) to pass through the focal point (11) of the lens and, thus, at a controlled direction. Although a converging lens is disclosed in the figure, a diverging lens could also be employed to achieve the same result.

A light ray (10) originating at the focal point (11) of the holopixel lens and traveling in a desired direction can thus be generated by turning “on” a pixel in the pixilated light source (9) in a binary fashion. The focal point (11) of the lens mimics a small point on a window or mirror. To minimize effects of spherical aberration, the lens (8) should be as close to perfect as possible and preferably have a relatively large radius of curvature.

In another embodiment (not shown), a holopixel can be constructed using a specialized DMD chip. Traditional DMD chips allow microscopic mirrors to tilt to reflect light from a separate source in one of only two directions: when a pixel is “on”, the mirror is tilted toward the viewer; when a pixel is “off”, the mirror is tilted toward a light sink. However, a DMD chip employing mirrors capable of tilting in any direction when a pixel is “on” would achieve the same result in the present invention as a standard DMD chip-lens pair, without the need for a converging lens, with its inherent disadvantages (such as spherical and chromatic aberration, for example).

When the holopixels are constructed using standard DMDs and lenses, a collimated light source is required to be pointed at the DMDs. This is necessary to ensure that substantially all light rays (10) strike the lens (8) at a 90 degree angle so that they will pass through the focal point (11). Other methods of collimating the light from the DMD are possible, however, and well known in the art.

To produce color images, a white LED can be used, in conjunction with a color wheel, similar to what is done in Digital Light Processing (DLP) televisions and projectors. Alternatively, three LEDs (for example, red, green, and blue), can be used to generate color light. In either case, the DMDs rapidly switch between displaying the red, green, and blue components of the desired image while the color wheel spins (or color LEDs alternate) in sync with the DMDs. All holopixels might share the same light source and color wheel, or each holopixel might contain its own light source or sources.

When lenses are used, geometric transformations might be necessary to compensate for chromatic aberration inherent in lenses by, for example, intentionally growing or shrinking the respective red, green, and blue images. Geometric transformations may also be necessary depending on the physical arrangement of holopixels in a display; for example, curved concave displays could allow viewers to see more perspectives of the represented space, but any software controlling the display would have to perform the required geometric transformations to transmit light representing various points in space to the appropriate holopixels. Such transformations are well known to ones of ordinary skill in the art of three dimensional graphics.

A holopixel also need not be a discrete device; rather, a single, very large DMD might be used to achieve the same results described above. A very large standard DMD can be logically sub-divided into equal two-dimensional regions, each constituting a pixilated light source, with a respective lens positioned appropriately with respect to each region, each region and lens together forming a holopixel. A very large specialized DMD, such as one described above, could similarly be logically sub-divided into holopixels without the need for lenses. Physically separating the holopixels does have advantages, however, which will be seen below.

These possible holopixel constructions are included only as exemplary. The exact method of constructing holopixels is not a limitation of the present invention, as long as the holopixel is capable of producing a plurality of light rays in controlled directions, and as long as each holopixel represents a different perspective of a three dimensional space.

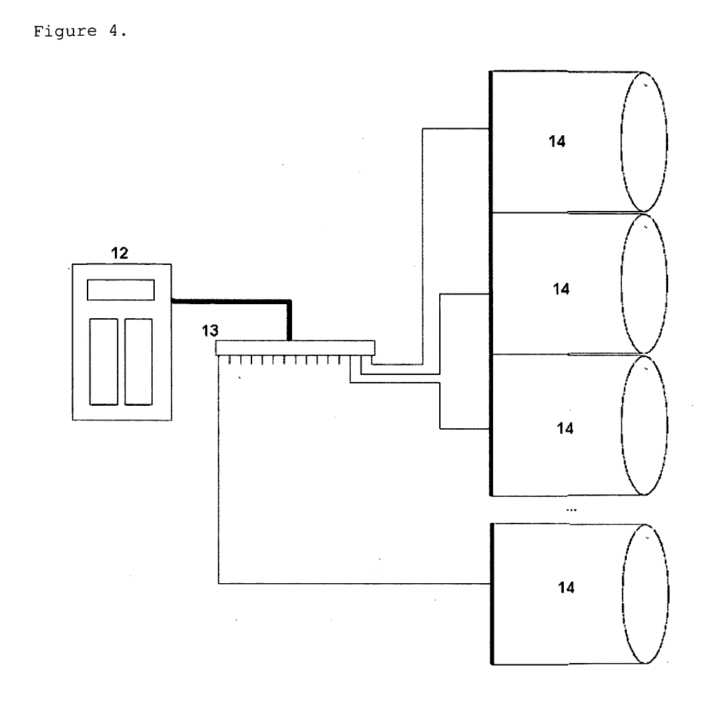

Turning now to a first preferred embodiment of the invention, referring to FIG. 4, a holographic display is disclosed. A data source (12) is coupled to a controller (13), which is, in turn, coupled to a plurality of holopixels (14). The controller (13) receives signals from the data source (12) instructing the controller how to operate the holopixels (14). For example, the signals might represent 24-bit bitmap image data, one image per holopixel, each image representing a different perspective of a three dimensional space. The signals might alternatively consist of logical instructions to illuminate certain portions of holopixels, which would be useful for generating vector-based images and text, reducing bandwidth requirements. The controller (13) can also perform any other necessary operations for the display, such as geometric transformations to compensate for chromatic aberration. Also, when DMDs are used, the controller (13) synchronizes the DMDs with the light sources and/or color wheel, as discussed above.

Because the light used is not coherent (i.e., is not a laser), it can be viewed directly by the eye. However, in large theatrical applications it may be desirable to shine the holographic display through a magnifying lens upon a reflective surface, such as a mirror. This would allow holographic projectors to be relatively small while still displaying images to a large audience.

The data can be created by a computer from a virtual three dimensional scene, can be pre-recorded or received from a broadcast, or can be obtained in real time, as will be discussed further below.

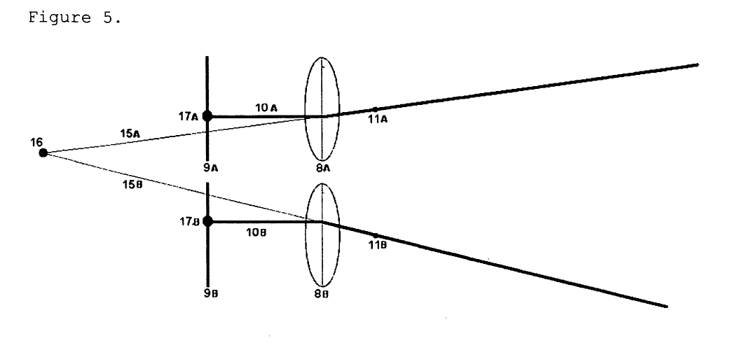

FIG. 5 exemplifies a computer generated hologram when the holopixels are constructed with DMDs and lenses. In this case, a ray tracing algorithm is employed. The computer generates appropriate bitmap data for each holopixel by mathematically tracing virtual light rays (15A, B) from each point (16) in a virtual space to the focal points (11A, B) of the lenses (8A, B) of the holopixels, determining the correct pixel (17A, B) on the DMD (9A, B) to activate in order to produce real light rays (10A, B) simulating the virtual traced ray (15A, B). The calculations used are well known to those of skill in the art and utilize the Lens Equation and other simple geometry. Although FIG. 5 demonstrates generating images of objects appearing “behind” the holographic display, the same technique can readily be employed to generate images appearing “in front of” the display. Dramatic three dimensional effects can be achieved in this fashion.

In another embodiment of the invention, the bitmap data can be obtained from a storage medium or a broadcast. Because the holographic data can be represented as a series of standard bitmapped images, existing formats can be used to compress, transmit, and store the data, for example, JPEG, MPEG-2, MPEG-4, Blu-Ray, etc.

In a third embodiment of the invention, the information representing a three dimensional space is created from a real image. Holographic sensors employing the same technique described above, except in reverse, can record a series of two-dimensional images each representing a different perspective of the same three dimensional space.

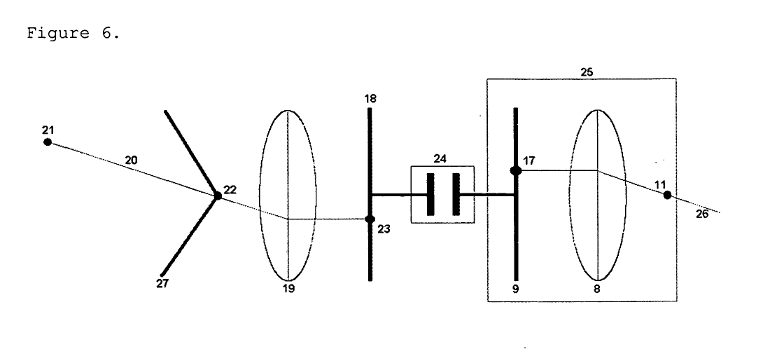

FIG. 6 discloses a holographic sensor coupled to a holopixel (25) utilizing a DMD and a lens. A light sensitive device (18), such as a Charged Coupled Device (CCD) or Complementary Metal-Oxide Semiconductor (CMOS) sensor, is paired with a converging lens (19). A light ray (20) originating at a real point in space (21), traveling through the focal point (22) of the lens (19), exits the lens (19) at a 90 degree angle, according to the Lens Equation, and, thus, directly at a specific point (23) on the light sensitive device (18). Light rays not traveling through the focal point (22) of the lens (19) are blocked by a shade (27) to reduce interference. Though this has the unfortunate effect of reducing light sensitivity of the sensor, all light striking the light sensitive device (18) directly will naturally be strongest. The effect is similar to a photograph taken with an extremely small aperture.

Each light sensitive device (18), thus obtains an inverted picture of the entire three dimensional space from a different perspective. The data recorded by each light sensitive device (18) can be modified, if desired, and stored in a storage device, broadcast, or used immediately, but, in any event, is eventually transmitted through some medium (24) to a corresponding holopixel (25) to create a light ray (26) simulating the original light ray (20). The original light ray (20), thus effectively continue its journey from the focal point (22) of the holographic sensor lens (19) to the focal point (11) of the holopixel lens (8).

An array of holographic sensors coupled to a storage device can be used to create a holographic camera for broadcast or distribution of holographic still images or movies. Alternatively, the option of using image data from holographic sensors in real time would be of use in stealth technology.

For example, a “mesh” of interwoven holopixels and holographic sensors can surround an object to be concealed, each holopixel mirroring the input of a corresponding holographic sensor on the opposite side of the object, tricking the human observer into seeing “through” the object. A holographic fence consisting of holopixels could also display a pre-recorded image.

There is no requirement that holopixels or holographic sensors be arranged in a flat plane; rather, a mesh of loosely connected holopixels and/or holographic sensors can be arranged in any desired shape, using geometric transformations, as described above, to adjust for the positioning of the holopixels and holographic sensors. Given holopixels and holographic sensors of sufficiently high resolution and small sizes, a holographic fabric could be constructed to conceal any conceivable object.

Obviously, the data bandwidth and storage requirements for full resolution lifelike images are extremely high, and it is therefore anticipated that initial applications of this invention will likely focus on computer-generated images such as simple shapes or text, or holographic still images. It is therefore not a limitation of the present invention that the produced images be lifelike or animated. Given the ever increasing availability of storage bandwidth and processing power, however, there is no theoretical limit to the quality of images produced by applications of this invention. Indeed, a high resolution hologram displayed on a 640×480 array of holopixels, each containing a 24-bit 640×480 DMD chip, for example, would require approximately 94 gigabytes of data—large, but not beyond the capability of today's computers.

It will be likewise be appreciated by one of ordinary skill that the above described embodiments are merely exemplary and are not intended to in any way limit the scope of the invention described herein.

I claim:

1. A method for electronically displaying an image representing a three dimensional space, comprising the steps of:
transmitting a plurality of light rays using a plurality of pixilated light sources; and
controlling the respective directions of said light rays;
whereby each pixel in a given one of said pixilated light sources represents a different point in said three dimensional space; and
whereby said three dimensional space is represented by a plurality of said pixilated light sources, each of said pixilated light sources representing a different perspective of said three dimensional space.

2. The method of claim 1, whereby the directions of said light rays are controlled using a plurality of lenses.

3. The method of claim 1, whereby said pixilated light sources are digital micromirror devices.

4. A system for electronically displaying an image representing a three dimensional space, comprising:
a plurality of pixilated light sources, each transmitting a plurality of light rays in controlled directions;
whereby each pixel in a given one of said pixilated light sources represents a different point in said three dimensional space; and
whereby said three dimensional space is represented by a plurality of said pixilated light sources, each of said pixilated light sources representing a different perspective of said three dimensional space.

5. The holographic display system of claim 4, further comprising a plurality of lenses, each paired with a pixilated light source.

6. The holographic display system of claim 4, wherein the pixilated light sources are digital micromirror devices.

7. The holographic display system of claim 6, further comprising a color wheel.

8. The holographic display system of claim 6, further comprising a plurality of collimated light sources.

9. The holographic display system of claim 4, further comprising a reflective surface, the light from said pixilated light sources being aimed at said reflective surface.

10. The holographic display system of claim 4, further comprising a controller for transmitting signals representing a three dimensional space to said pixilated light sources.

11. The holographic display system of claim 4, further comprising a storage device for storing and retrieving information representing said three dimensional space.

12. The holographic display system of claim 4, wherein said signals representing said three dimensional space are generated by a computer.

13. The holographic display system of claim 4, wherein said signals representing said three dimensional space are generated from a recording of a real image.

14. The holographic display system of claim 4, further comprising a plurality of light sensitive devices, each of said light sensitive devices recording an image of said three dimensional space from a different perspective, whereby said images are displayed by the respective ones of said pixilated light sources.
